(19) United States
(12) Patent Application Publication
(10) Pub. No.: US 2009/0145055 A1
(43) Pub. Date: Jun. 11, 2009

(54) Landscape Edging Assembly

(76) Inventors: Mark Remke, Roselle, IL (US); JoAnn Remke, Roselle, IL (US); Michael Remke, Roselle, IL (US); James Remke, Roselle, IL (US); Jim Lutz, Downers Grove, IL (US); Phillip Dwyer, Utica, MI (US)

Correspondence Address: COOK ALEX LTD, SUITE 2850, 200 WEST ADAMS STREET, CHICAGO, IL, 60606, US

(21) Appl. No.: 12/191,873

(22) Filed: Aug. 14, 2008

Related U.S. Application Data
(60) Provisional application No. 60/956,090, filed on Aug. 15, 2007.

(51) Int. Cl. A01G 1/08; E04C 2/20; E02D 17/08; E02D 5/80

(52) U.S. Cl. 52/102; 52/309.1; 405/302.7; 52/155; 52/741.11

(57) ABSTRACT

A landscape edging assembly has a sleeve made of geo-textile fabric with a hardenable filler therein, such as concrete. Reinforcing fibers are dispersed throughout the filler. The filler is activated by immersing it in water. Thereafter the still-pliable edging assembly is placed adjacent the peripheral edges of a paving material and pressed into engagement therewith. Anchors engageable with the sleeve may be driven into the ground to retain the cured edging assembly in place.

### CROSS-REFERENCE TO RELATED APPLICATION

This application claims the benefit of U.S. Provisional Application No. 60/956,090, filed Aug. 15, 2007, the disclosure of which is hereby incorporated herein by reference.

### BACKGROUND

The present subject matter described herein relates to a landscape edging assembly and a method for installing the assembly. It is particularly intended for use with paving materials, although it can be used wherever a boundary between two ground areas is defined.

Conventionally when a ground surface is paved with materials such as bricks or decorative stones a material such as crushed stone or gravel or the like is laid as a sub-base on top of a prepared ground surface. Next, sand is laid on top of the sub-base material to create a smooth bedding surface upon which to lay the paving material. Then, a plurality of bricks or decorative stones are installed on top of the sand, frequently in some sort of decorative pattern or layout. Finally, an edging material is placed along the edge of the layout where the paving abuts the adjacent unpaved surface, whether a lawn, bed or other adjacent surface. The edging is intended to provide a uniform peripheral edge conforming to the paving layout while at the same preventing the paving material from horizontally shifting over time.

Conventional edging typically consists of an elongated member having a generally L-shaped body, designed such that the shorter, horizontal leg of the body tucks under the outer-most brick of the paved surface and the longer, vertical leg interfaces between the paved surface and the adjacent unpaved area. However, because only a small portion of the edging material is secured under the paved surface these edging systems have a tendency to move over time as the bricks shift and settle, resulting in an inconsistent peripheral edge.

Conventional edging strips of the type referred to are constructed from rubber, plastic, or aluminum. However, these materials offer limited flexibility and horizontal stability, making them ill-suited for maintaining the paving material in proper alignment.

Another problem found in conventional edging systems is that if turf is placed along the edge of the paving, it often does not grow properly. The turf along the edge of the paved surface is exposed to higher temperatures because the edging materials absorb heat from the paving and transfer it to the turf. This results in an inconsistent and unattractive transition between the lawn and the paved surface.

Finally, because of their limited flexibility, conventional edging systems have to be cut and fitted in order to follow curves and corners. As a result, conventional edging systems cost more to install because of the additional time and labor required. This, combined with the relatively high cost of the materials, makes for an expensive job.

### SUMMARY

It is, therefore, an object of the present invention to provide an improved landscape edging assembly and method for installing it that overcome the shortcomings and limitations of the prior art.

It is another object of the present invention to provide a landscape edging assembly that tightly molds to the peripheral edge of the paving.

It is still another object of the present invention to provide a landscape edging that permits proper lawn growth along the peripheral edge of the paving.

It is a further object of the present invention to provide a landscape edging that is more cost effective and is relatively quick and easy to install.

Yet another object of the invention is a landscape edging that is durable and will not crack or separate easily.

A still further object of the invention is a landscape edging that can be used with paving materials of variable profile or height.

These and other desired benefits of the invention, including combinations of features thereof, will become apparent from the following description. It will be understood, however, that an assembly could still appropriate the claimed invention without accomplishing each and every one of these desired benefits, including those gleaned from the following description. The appended claims, not these desired benefits, define the subject matter of the invention.

The landscape edging assembly of the present invention has a sleeve of flexible geo-textile material defining an enclosed cavity in which a hardenable filler is placed. Optional reinforcing elements are dispersed generally throughout the filler. Prior to installation the filler is pliable but at installation the filler is activated so that once in place it cures over time and ultimately becomes rigid. Concrete is a preferred filler material. The landscape edging assembly is soaked in water just prior to installation to activate the concrete. The sleeve is pressed into place at a boundary, such as adjacent to the peripheral edge of paving material, so that it conforms to the contour of the boundary. Optional connecting members may be used to operably connect adjacent sleeves. Moreover, anchors may be placed through or adjacent to the sleeve to help hold it in place. Once the concrete cures the edging assembly provides a strong structure at the boundary that retains the pavers or other material in place.

The present invention further comprises the method of installing a landscape edging including the steps of prefilling a flexible sleeve with a hardenable material, activating the hardenable material at the installation site, placing the sleeve with activated hardenable material at the boundary of the ground feature, and curing the hardenable material.

### BRIEF DESCRIPTION OF THE DRAWINGS

FIG. 1 is perspective view of an open end of the edging sleeve, showing the filler and a plurality of reinforcing elements therein.

FIG. 2 is a plan view of an edging sleeve coiled for storage or shipment.

FIG. 3 is a perspective view of an edging sleeve pressed into place adjacent paver bricks.

FIG. 4 is a vertical section through a pavement with the landscape edging assembly of the present invention installed.

FIG. 5 is a perspective view of two edging sleeves operably connected.

FIG. 6 is a perspective view of two edging sleeves operably connected around a corner.

### DETAILED DESCRIPTION

FIGS. 1 and 4-6 illustrate a preferred embodiment of the landscape edging assembly of the present invention. The landscape edging assembly, designated generally at 10, includes a sleeve 12 filled with a hardenable filler 14. Optionally, there is a plurality of reinforcing elements dispersed throughout the filler. In one embodiment, adjacent sleeves may be operably connected by a connecting member. In another embodiment, the filled sleeve may be held in place by a plurality of spaced anchors, one of which is seen at 18 in FIG. 4. The anchors secure the sleeve 12 at a boundary on a ground feature. Typically, but not necessarily, the boundary is the peripheral edge of paving 20 and the sleeve lies in engagement with the paving. The paving 20 rests on a base or bedding 22. Depending on the paving material there may also be a sub-base 24 prepared on top of the soil substrate 26.

The ground feature to which the anchors 18 are attached may be a portion of the sub-base 24 and base 22 which extends beyond the peripheral edge of the paving 20. This is the arrangement shown in FIG. 4. Alternately, the sub-base and base may terminate at the outer peripheral edge of the paving 20. In this case the sleeve would rest on the soil substrate 26 adjacent the base and sub-base and the ground feature to which the anchors are attached would be the soil substrate 26. A common material for the base or bedding 22 is sand. If a sub-base 24 is used it can be stone or gravel of a size suitable for stabilizing the substrate 26.

The paving 20 can be any of the typical landscape paving materials such as pavers of all types, bricks, flagstone, bluestone, sandstone, limestone, cobblestone, gravel, asphalt, crushed stone, decorative bark or the like. These are generally used to create a patio, driveway, sidewalk, path, pool deck or other hard surface feature. The peripheral edge is the outermost edge of the paving 20 that abuts the adjoining unpaved area, such as a lawn, bed or other surface. The landscape edging assembly 10 adapts and molds against the peripheral edge of the paving 20. Consequently, the landscape edging assembly 10 prevents the paving 20 from shifting laterally and maintains a consistent peripheral edge.

The sleeve 12 has a generally tubular configuration defined by a circumferential wall 28. The sleeve is preferably made of a durable yet flexible material so that the configuration of the sleeve can adapt to the peripheral edge of the paving 20. That is, the sleeve can at least bend around curves and corners of paving and yet still be strong enough not to fail during manufacture, filling, shipment, installation or use. Additionally, the material of the sleeve should be water permeable to allow water to reach the filler inside the sleeve. Preferably, the sleeve is fabricated from synthetic or organic geo-textile fabrics. In one embodiment, the fabric is cut into a ten-foot long strip; however, the selected length is merely for example and other suitable lengths may be used. Then, one side edge is folded onto the other edge and an elongated seam 30 is sewn with a suitable synthetic or organic thread to bind the side edges together. Alternatively, the side edges may be bound together by adhesive, metal fasteners, heat sealing, knotting or any other suitable means for adhering the side edges together. By way of example only, the dimensions of the fabric strip are chosen to result in a sleeve that is approximately 1-4 inches in diameter and approximately 10 feet in length; however, other dimensions are possible.

The sleeve's circumferential wall 28 defines a cavity within the sleeve. The cavity is filled with a hardenable filler. The hardenable filler may be any of a variety of fillers; however, a preferred filler is concrete and more specifically, a high strength, quick set concrete mix. Preferably the aggregate used in the concrete mix can include any of the following or a combination thereof: derivatives from any rock, sand combinations, steel mill by-products, clays, organic or inorganic fillers, organic or inorganic adhesives, plastic or its by-products, rubber or its recycled derivatives, naturally occurring lightweight aggregates, or any other suitable material used as filler. When exposed to the proper amount of water the concrete mix starts the process of setting as concrete. During this setting process, the sleeve is able to mold to the peripheral edge of the paving. Upon setting, the sleeve has the strength to prevent the paving from shifting.

Optionally, a plurality of reinforcing elements are dispersed throughout filler in the cavity of the sleeve. The reinforcing elements can be fabricated from any material that can reinforce the concrete mix, such as synthetic, organic or metal fibers, strips, or continuous lineal portions, including fiberglass. In an exemplary embodiment illustrated in FIG. 1, the reinforcing elements are poly “mini re-bars” 16 that are two inches in length and have a diameter of about 1/32 to 1/16 inches; however, these dimensions are only exemplary and other sizes of poly “mini rebars” may be used. Preferably, there should be hundreds of poly “mini re-bars” per cubic yard of the sleeve. In one embodiment, the poly “mini re-bars” may be macro synthetic fibers sold by Propex Concrete Systems Corp. of Chattanooga, Tenn. under their trademark ENDURO® 600. Alternatively, the reinforcing elements may consist of fibers 17 in the form of so-called “angel hair”, i.e. round, polypropylene or fiberglass fibers, for example, FIBERMESH® 150, also sold by Propex Concrete Systems Corp. Preferably, there should be approximately 1-1.5 lbs of FIBERMESH® 150 per cubic yard of the sleeve. Of course, any combination of the mini re-bars and angel hair reinforcing elements may be used to provide increased tensile strength to the set concrete mix and help provide the support needed to prevent the paving from shifting.

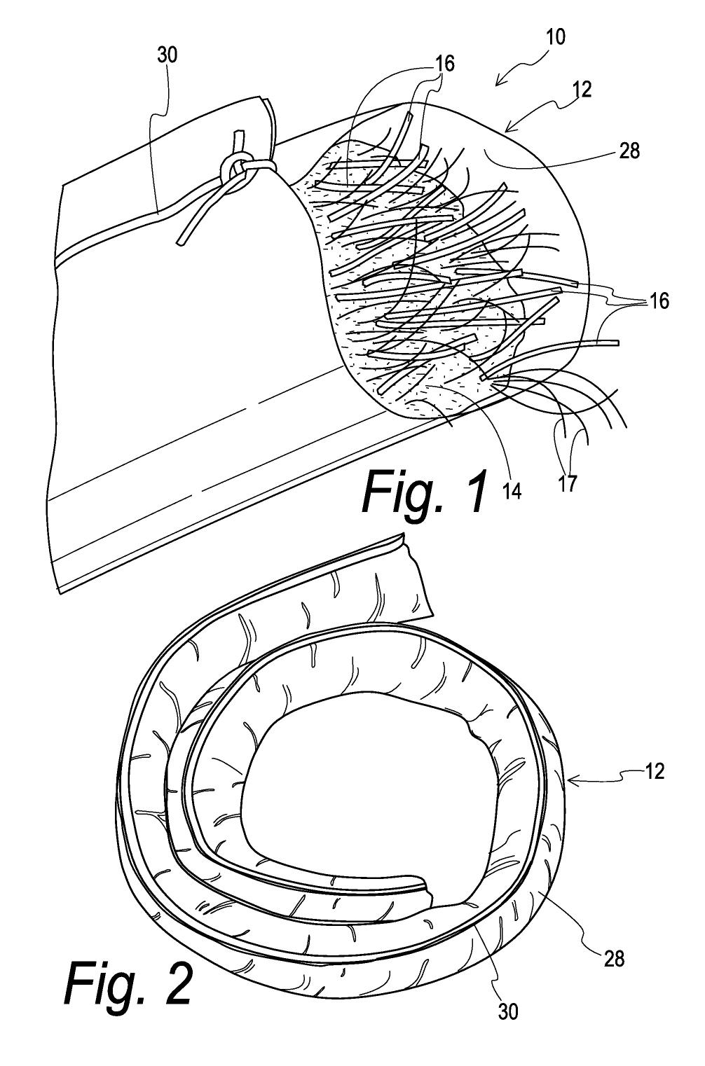

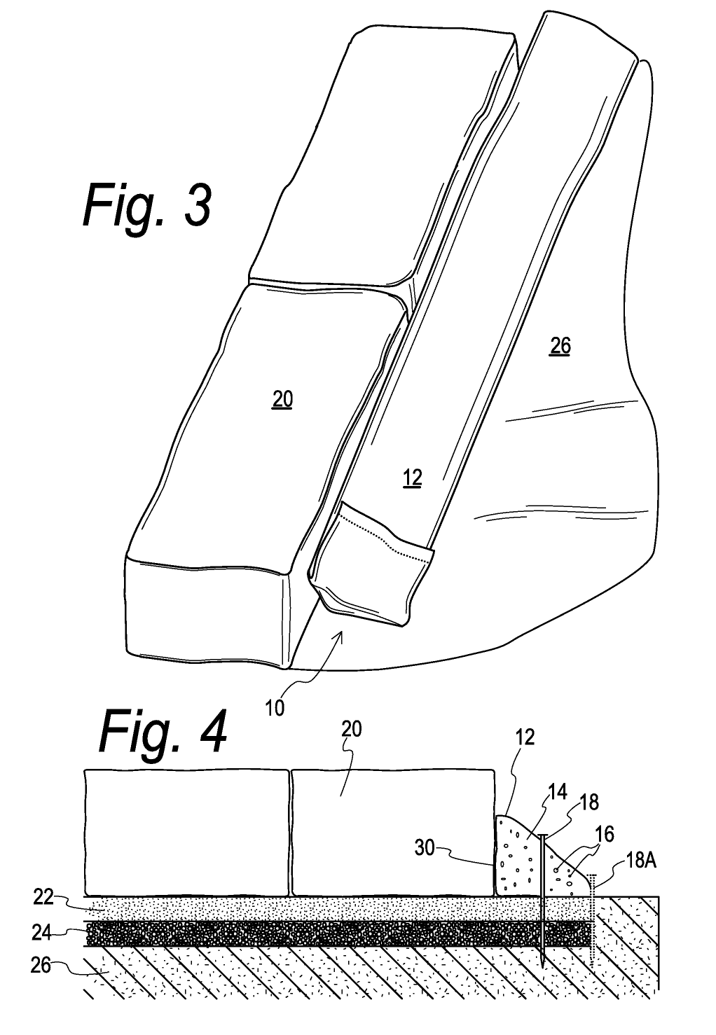

FIG. 1 shows the sleeve with an end open for introducing the filler into the cavity of the sleeve. After filling is finished, the ends of the sleeve are closed, as best seen in FIG. 2. The filler is kept out of the last several inches of the sleeve. This permits the end closure to be formed by folding the empty end portion of the sleeve back on itself. This folded portion is retained in the folded condition by, for example, a knot, organic or synthetic thread, adhesive strips, metal fasteners such as staples, heat sealing, or any other means suitable for closing the sleeve. The ends are closed to prevent the concrete mix and reinforcing elements of the cavity from spilling out of the sleeve unexpectedly. Thus, the completed sleeve defines an enclosed cavity which retains the filler and optional reinforcing elements.

The use, operation and function of the landscape edging assembly are as follows. Installation begins by submersing the entire sleeve in a shallow tub of water for approximately 4-5 minutes. This is most conveniently done with the sleeve coiled as shown in FIG. 2. This step should wet the concrete mix throughout the entire the cavity and begin the concrete solidification process. This process can be sped up by shaking or rolling the sleeve underwater.

The sleeve is then removed from the tub of water and placed lengthwise at the intended boundary, such as against the peripheral edge of the paving. Preferably, the seam 30 is placed down next to the paver 20. The sleeve will follow all dips, slopes and curves of the peripheral edge of the paving. The sleeve can take virtually an infinite number of shapes. By way of example only and by no means limiting, the sleeve can be a straight shape, a curved shape, a corner shape, and any combination of those shapes. The landscape edging assembly 10 allows multiple sleeves to be coupled end-to-end in a series as needed to match the length of the peripheral edge of the paving.

With a foot, hand or other device the wetted sleeve is firmly pressed up against the peripheral edge of the paving such that there is no gap between the sleeve and peripheral edge of the paving. Preferably, the sleeve is pressed into a triangular cross-section at about a 45° angle as seen in FIG. 4. Other shapes are possible but the triangular shape shown is easiest to form. For low profile paving materials, the sleeve can be pressed downwards until it reaches the desired height. If there is excess sleeve length where the sleeve reaches the end of the paving material, the sleeve can be cut with a utility knife about 2 inches past the dead head. The concrete is then removed from the last 2 inches of the sleeve. The empty fabric is folded back under the sleeve. In one embodiment, a spike or anchor may be driven next to or through the sleeve to hold the fold in place.

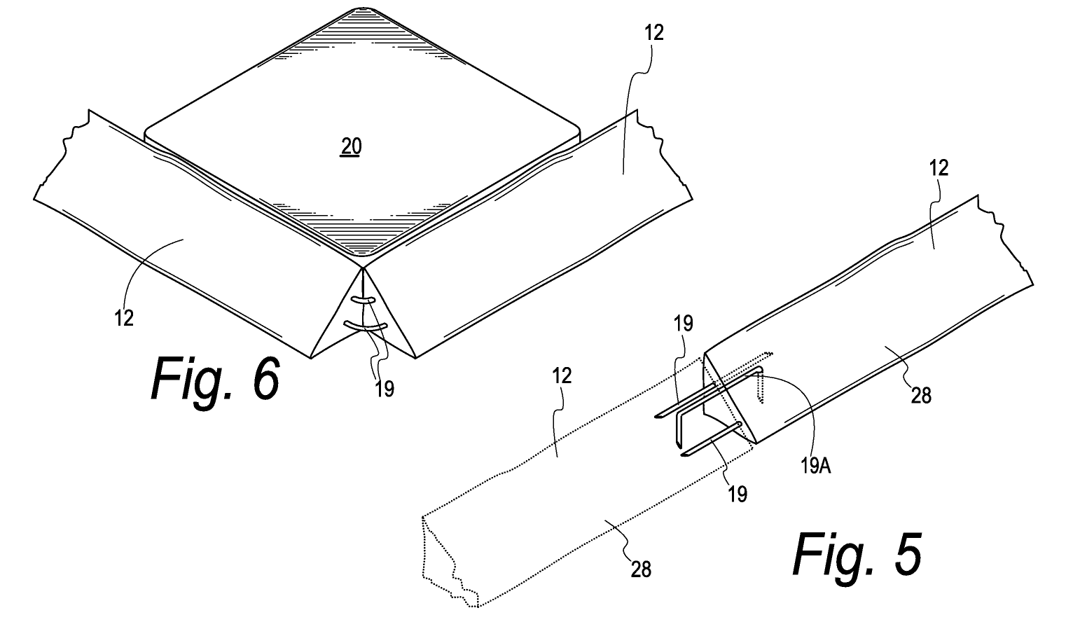

Optionally, adjacent sleeves are operably coupled in order to help hold the sleeves in place against the peripheral edge of the pavers and prevent any unwanted movement or discontinuity of the pavers. In one embodiment, adjacent sleeves are operably coupled by at least one connection member that interacts with the sleeves. More specifically, the connection member may be a pin, staple, stake, casing or any other suitable structure that can couple adjacent sleeves together. As illustrated in FIG. 5, the pin 19 is a relatively straight member that preferably has ends that define a point. The pointed ends allow the pin to be inserted relatively easily into the ends of sleeves. In an exemplary embodiment, the pin is generally an 8 inch long and 0.140 inch diameter wire with angled ends; however, these dimensions are only exemplary and other sizes of wire may be used. Preferably, the wire may be constructed of a relatively stiff material, for example, steel; however, any other suitable material may be used.

In use, after the sleeves are wetted and generally in place, at least one pin is partially inserted into the end of a first sleeve leaving a portion of the pin extending from the end of the first sleeve. The end of a second sleeve is then advanced toward the first sleeve such that the portion of the pin extending from the end of the first sleeve enters the end of the second sleeve. Preferably, the sleeves are pushed together such that the end of the first sleeve abuts the end of the second sleeve. The sleeves may then be pressed up against the peripheral edge of the paving as described above and allowed to cure. Alternatively, or in addition to the pins 19 penetrating the ends of the sleeve, there may be a connection member in the form of a U shaped pin, such as shown at 19A in FIG. 5. The U shaped pin, has a leg advanced through the circumferential wall 28 of two abutting sleeves, such as shown at 19A in FIG. 5.

The connection member may be also be used to link sleeves around a corner. In one embodiment illustrated in FIG. 6, at least one pin 19 is inserted into the end of the first sleeve and then bent around the corner and inserted into the end of a second sleeve. Of course, there may be alternative arrangements of sleeves around a corner. For example, the first sleeve may be butted up against a second sleeve's circumferential wall (not the end of the second sleeve). The pin inserted in the end of the first sleeve may then be inserted through the body of the second sleeve.

In order to help hold the sleeve in place against the peripheral edge of the pavers, a plurality of anchors, one of which is shown at 18, may optionally be used. The anchors may be of any variety of anchoring device. For example, the anchor could be a 10 or 12 inch steel nail, spike, or metal stake. Of course, any other suitable structure that holds the sleeve in place against the peripheral edge may be used. The nail or spike is driven through the sleeve approximately every 18 to 24 inches along the length of the sleeve. This must be performed while the concrete mix is still wet and workable. Alternatively, or in addition to the anchors penetrating the sleeve, there may be anchors placed adjacent the outer edge of the sleeve, such as shown at 18A in FIG. 4. After anchoring, the sleeve preferably should again be firmly pressed up against the peripheral edge of the paving material to compress any loosening caused by driving the anchors through the sleeve. Then the sleeve is left undisturbed until it cures. Curing time depends on the ambient temperature, but can be as little as half an hour in hot weather. After complete curing the volume above the sleeve may be backfilled, if desired, to blend the level of the surrounding soil with the top surface of the paving.

In certain climates freeze-thaw cycles may tend to loosen or dislodge the anchors. In such cases a larger sleeve diameter, on the order of three inches or more, may be used to keep the edging assembly in place without the use of anchors. Even where freeze-thaw cycles are not a concern, the larger sleeve diameter can be used as a substitute for the use of anchors. It will be understood that regardless of climate characteristics, some paving materials will not require anchors or the larger sleeve diameter.

It will be understood that the embodiments of the present invention which have been described are illustrative of some of the applications of the principles of the present invention. Numerous modifications may be made by those skilled in the art without departing from the true spirit and scope of the invention, including those combinations of features that are individually disclosed or claimed herein. For example, the sleeve could have a cross-sectional shape other than the circular shape shown. The anchors could have an alternate form, such as stamped metal parts or U-shaped or L-shaped pins. In some application adhesives could be used to anchor the sleeve to the ground feature. In other applications it may not be necessary to use anchors at all. The edging assembly could also be used by itself as an erosion control dam to slow or direct water runoff. It could be used as a border edging around gardens, flower beds, trees and shrubs. In such applications the use of anchors may not be required. It is also possible that the reinforcing elements may not be required in less demanding applications such as separating flower beds from turf areas. Thus, it will be understood that the present invention contemplates a landscape edging assembly that includes a sleeve and filler, as well as an assembly that has a sleeve and filler plus one or both of the anchors and reinforcing elements.

It will also be understood that the present invention comprises the method of installing a landscape edging including the steps of prefilling a flexible sleeve with a hardenable material, activating the hardenable material at the installation site, placing the sleeve with activated hardenable material at the boundary on the ground feature, and curing the hardenable material. While it is contemplated that ordinarily the prefilling step will be performed in a factory setting, with the filled, uncured sleeves then being shipped to a job site, it could be otherwise. It would be possible to transport just the empty sleeves (and reinforcing elements if needed) to a job site and then fill the sleeves with the selected filler and reinforcing elements at the site. Obviously after filling the ends of the sleeves would be sealed appropriately. Then the installation could be completed as described above.

We claim:

1. A landscape edging assembly for installation at a boundary on a ground feature, the edging assembly comprising:
at least one flexible sleeve defining an enclosed cavity; and
a hardenable filler in the cavity of the sleeve.

2. The landscape edging assembly of claim 1 wherein the hardenable filler further includes a plurality of reinforcing elements.

3. The landscape edging assembly of claim 2 wherein the plurality of reinforcing elements include poly re-bars.

4. The landscape edging assembly of claim 2 wherein the plurality of reinforcing elements include polypropylene fibers.

5. The landscape edging assembly of claim 1 wherein the sleeve consists of a flexible geo-textile material.

6. The landscape edging assembly of claim 1 further including at least one anchor which is engageable with the sleeve.

7. The landscape edging assembly of claim 1 further including a second flexible sleeve defining an enclosed cavity; and a hardenable filler in the cavity of the second sleeve.

8. The landscape edging assembly of claim 7 wherein the at least one flexible sleeve and the second sleeve are operably connected.

9. The landscape edging assembly of claim 8 wherein the at least one flexible sleeve and the second sleeve are operably connected by at least one connection member.

10. The landscape edging assembly of claim 9 wherein the connection member is a pin.

11. The landscape edging assembly of claim 9 wherein the connection member is U-shaped.

12. A method of installing a landscape edging assembly at a boundary on a ground feature, the method comprising:
prefilling at least one flexible sleeve with a hardenable material;
activating the hardenable material at the installation site;
placing the at least one sleeve with activated hardenable material at the boundary on the ground feature; and
curing the hardenable material.

13. The method of claim 12 further including the step of securing the at least one flexible sleeve in place at the boundary of the ground feature with at least one anchor.

14. The method of claim 12 further including the steps of:
prefilling a second flexible sleeve with a hardenable material;
activating the hardenable material at the installation site;
placing the second sleeve with the activated hardenable in operable connection with the at least one flexible sleeve material at the boundary on the ground feature.

15. The method of claim 14 wherein the sleeves are placed in operable connection by at least one connection member.
